(19) United States
(12) Patent Application Publication
(10) Pub. No.: US 2025/0225518 A1
(43) Pub. Date: Jul. 10, 2025

(54) Multi-Factor Authenticated Virtual Transaction Systems And Methods

(71) Applicant: Shoebx Corporation, Weston, FL (US)

(72) Inventors: Gary Chaikin, Toronto (CA); Nishil Patel, Weston, FL (US)

(73) Assignee: Shoebx Corporation, Weston, FL (US)

(21) Appl. No.: 18/847,229

(22) PCT Filed: Apr. 21, 2023
(86) PCT No.: PCT/US23/19432

§ 371 Date: Oct. 6, 2024

Related U.S. Application Data
(60) Provisional application No. 63/333,215, filed on Apr. 21, 2022.

(51) Int. Cl. G06Q 20/40

(52) U.S. Cl. CPC G06Q 20/40145; G06Q 20/4016

(57) ABSTRACT

According to an embodiment, a multi-factor authenticated virtual transaction method of an intermediary processor may be provided. The method may include receiving, into the intermediary processor, a transaction initiation signal, generating a biometric challenge signal in response to the receiving of the transaction initiation signal, transmitting, towards a virtual terminal, the biometric challenge signal, receiving, from the virtual terminal, a biometric input signal including biometric input, and comparing the received biometric input and a biometric token to determine whether a match occurs. When the match does not occur, transmitting a biometric match fail signal to the virtual terminal. When the match does occur, generating an authorization request signal, transmitting the authorization request signal towards an authorization processor, and receiving a response to the authorization request signal.

### CROSS-REFERENCE TO RELATED APPLICATION

The present application claims priority to and benefits of U.S. Provisional Appl. No. 63/333,215, filed on Apr. 21, 2022 in the United States Patent and Trademark Office, the entire contents of which are incorporated herein by reference.

### BACKGROUND

The present disclosure relates to multi-factor authenticated virtual transaction systems and methods. Many different virtual worlds (multi-dimensional computer-based online community environments experienced by persons through representative avatars) exist today. Non-limiting examples include gaming worlds and conference worlds. Transaction systems in the physical world exist today, and generally require presence in the physical world to access.

### SUMMARY

Many different aspects of the present disclosure may be provided in differing embodiments. However, a few non-limiting example embodiments are now summarized by way of brief introduction to a few novel methods.

According to an embodiment, a multi-factor authenticated virtual transaction method of an intermediary processor may be provided. The method may include receiving, into the intermediary processor, a transaction initiation signal, generating a biometric challenge signal in response to the receiving of the transaction initiation signal, transmitting, towards a virtual terminal, the biometric challenge signal, receiving, from the virtual terminal, a biometric input signal including biometric input, and comparing the received biometric input and a biometric token to determine whether a match occurs. When the match does not occur, transmitting a biometric match fail signal to the virtual terminal. When the match does occur, generating an authorization request signal, transmitting the authorization request signal towards an authorization processor, and receiving a response to the authorization request signal.

According to an embodiment, a multi-factor authenticated virtual transaction method of a virtual terminal may be provided. The method may include generating a transaction initiation signal, transmitting, towards an intermediary processor, the transaction initiation signal, receiving, from the intermediary processor, a biometric challenge signal, receiving a biometric input, and transmitting the biometric input signal toward the intermediary processor.

However, aspects of the disclosure are not limited to those described above. Other aspects are described in the following descriptions and will be apparent to those of ordinary skill in the art.

### BRIEF DESCRIPTION OF THE DRAWINGS

FIG. 1 illustrates a physical user immersed in a virtual world as an avatar;

FIG. 2 illustrates an authorization processor;

FIG. 3 illustrates a physical user immersed in a virtual world with an avatar credential and a virtual terminal according to an embodiment of the disclosure;

FIG. 4 illustrates a method for generating an individualized avatar credential according to an embodiment of the disclosure;

FIG. 5 illustrates a method for generating a virtual terminal according to an embodiment of the disclosure;

FIG. 6 illustrates a method for linking a virtual terminal used inworld to a physical world loyalty program according to an embodiment of the disclosure;

FIG. 7 illustrates a multi-factor virtual transaction according to an embodiment of the disclosure;

FIG. 8 illustrates a signal diagram of a multi-factor authenticated virtual transaction method according to an embodiment of the disclosure;

FIG. 9 illustrates a method executing on a virtual terminal according to an embodiment of the disclosure; and

FIG. 10 illustrates a method executing on an intermediary processor according to an embodiment of the disclosure.

### DETAILED DESCRIPTION

The disclosure will now be described more fully hereinafter with reference to the drawings, in which sample embodiments are shown. However, this disclosure may be embodied in different forms and should not be construed as limited to the embodiments set forth herein.

References to the singular forms, “a,” “an,” and “the” are intended to include the plural forms as well, unless the context clearly indicates otherwise. The terms “and” and “or” may be used in the conjunctive or disjunctive sense and may be understood to be equivalent to “and/or.”

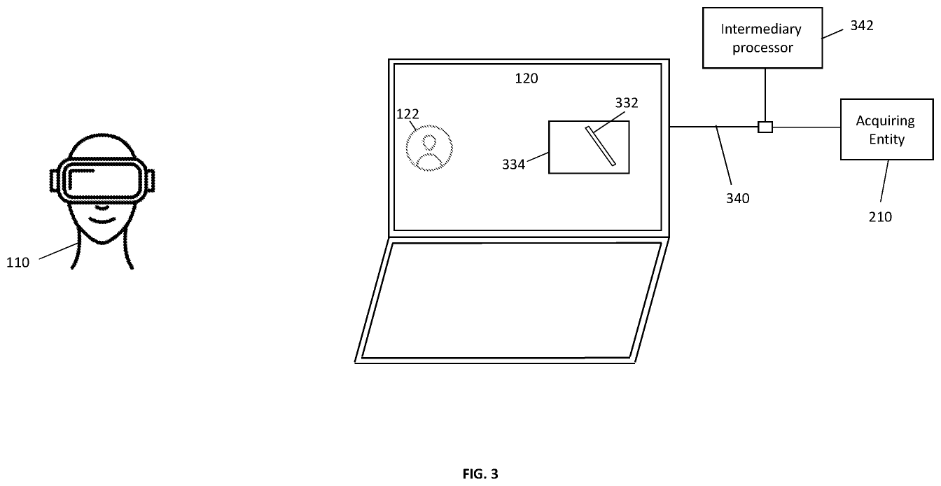

When an element (such as virtual terminal 334 of FIG. 3 for example) is referred to as being “connected to” another element (such as acquiring entity 210 of FIG. 3 for example) in the specification, it can be directly connected, or intervening elements (such as intermediary processor computing device 342 of FIG. 3 for example) may be disposed therebetween.

Embodiments of the present disclosure provide multi-factor authenticated virtual transaction systems and methods. The multi-factor authentication may include at least one intermediary processor authentication as well as at least one authorization processor authentication. In an embodiment, the intermediary processor authentication and/or the authorization processor authentication may involve a biometric verification and/or account verification. Biometric verification may involve one or more of voice recognition, iris recognition, fingerprint recognition, face recognition, retina recognition, deoxyribonucleic acid (DNA) recognition, and/or the like. Account verification may include computer user account verification, funds availability verification, credit availability verification, and/or the like. In the interest of brevity, embodiments leveraging fingerprint recognition and funds/credit availability verification are discussed merely as examples.

For context, a brief overview of virtual worlds and transaction systems is first provided.

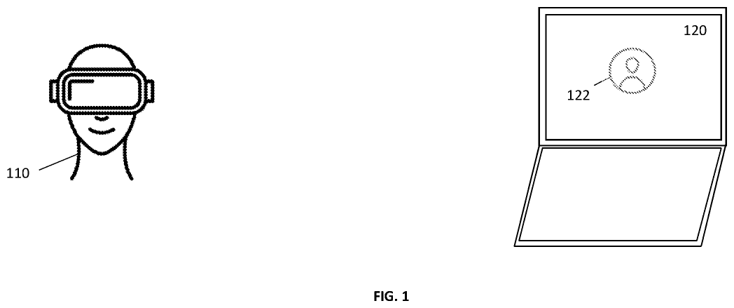

FIG. 1 is a schematic representation of a physical user 110 immersed in a virtual world 120 as an avatar 122.

A physical user 110 may be a physical person or an entity in the physical world (e.g., a business or other organization in the physical world). An avatar 122 may be a computer representation of the physical user 110. It should be noted that avatar 122 can be broadly interpreted to also include predefined characters and the like. A virtual world 120 may be a multi-dimensional computer-based online community environment experienced by physical users through representative avatars. The metaverse may be a collection of multiple virtual worlds 120. Virtual world 120 and metaverse can be broadly interpreted to include both virtual reality and augmented reality. In-world may refer to entities, experiences, or other elements within the metaverse (e.g., within one or more virtual worlds 120). A conceptual intersection may exist between the metaverse and the physical world and may be referred to herein as an inworld/physical world intersection.

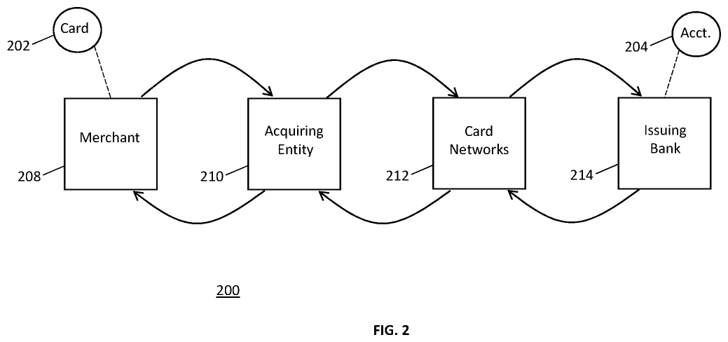

FIG. 2 is a schematic representation of an authorization processor 200, such as a card transaction process. Other transaction processes that may be applicable include network transaction processes, bank account transaction processes, and other account transaction processes.

Turning to the illustrated card transaction process merely as an example, a card 202 may be a credit card or a debit card issued to a physical user enabling the physical user to purchase goods or services on credit or by debiting a bank account 204. In another embodiment, a card 202 may be a stored value card (e.g., a gift card). An electronic card transaction may be a card payment or refund on behalf of a physical user according to a typical card transaction process 200. A typical card transaction process 200 may involve an acquiring bank (processor) 210, a card network 212, and an issuing bank 214. An acquiring bank 210 may be an entity (e.g., bank or financial institution) that processes electronic card transactions on behalf of a merchant 208. A card network 212 may a company providing a communication system between a merchant 208 (e.g., via an acquiring bank) and an issuing bank 214. An issuing bank 214 may issue the card to the physical user and may commit to the payment of the electronic card transaction on behalf of the physical user, assuming sufficient funds/credit. A payment terminal may be a physical point of sale device (e.g., computing device at the merchant 208 in communication with the acquiring bank 210) that interfaces with a card 202 to process a purchase or refund from the merchant 208 by the physical user.

In contrast with embodiments of the present disclosure, conventionally a physical user 110 that is immersed within a virtual world 120 and represented as an avatar 122 may not be able to readily take advantage of an authorization process such as the typical card transaction process 200 without first exiting the virtual world 120. Even transaction systems (e.g., payment systems) specifically configured for use with the metaverse typically require exit from a virtual world 120 to a separate payment area where physical card information must be entered and/or stored.

In contrast with the typical approach of today, the present disclosure provides multi-factor authenticated virtual transaction systems and methods.

FIG. 3 is a schematic representation of a physical user 110 immersed in a virtual world 120 including an avatar credential 332 and a virtual terminal (or virtual payment terminal or virtual transaction terminal) 334 according to an embodiment of the disclosure. The avatar credential 332 and the virtual terminal 334 may form a lock and key system.

In an embodiment, when the avatar credential 332 is created, the physical user 110 may be prompted to input biometric information. The input biometric information may be used to create a unique biometric token. The biometric token may be associated with the physical user's avatar 122. In an embodiment, the biometric token may be the avatar credential 332.

It should be noted that while FIG. 3 shows a graphical representation of the avatar credential 332 inworld, the biometric token may exist at and be stored by the intermediary processor 340 (e.g., a physical world intermediary processor computing device 342).

According to an embodiment of the disclosure, the virtual terminal 334 may be provided inworld 120 in communication through the inworld/physical world intersection via an intermediary processor 340 (or gateway) between the virtual terminal 334 and an authorization processor 200 (e.g., a typical card transaction process). It should be noted that references herein to a “virtual world” can be interpreted as to the “metaverse”, which as noted above, may be a collection of virtual worlds 120.

In an embodiment, the intermediary processor 340 may include a secure connection from a virtual terminal 334 inworld in a virtual world 120 through the inworld/physical world intersection to a physical world intermediary processor computing device (or gateway access computing device) outside of the virtual world 120. The physical world intermediary processor computing device 342 may be connected to a computing device of an authorization processor 200 (e.g., a computing device of an acquiring bank 210). In an alternative embodiment, the intermediary processor 340 may include a secure connection from the virtual terminal 334 inworld in the virtual world 120 to a computing device of the authorization processor 200 (e.g., from the virtual terminal 334 to the computing device of the acquiring bank 210).

The virtual terminal 334 (and related methods) may be agnostic in that the virtual terminal 334 may be generalized such that it is interoperable among different virtual worlds 120 regardless of differences between said different virtual worlds 120. For example, the virtual terminal 334 may function in virtual worlds 120 provided by different and unrelated organizations.

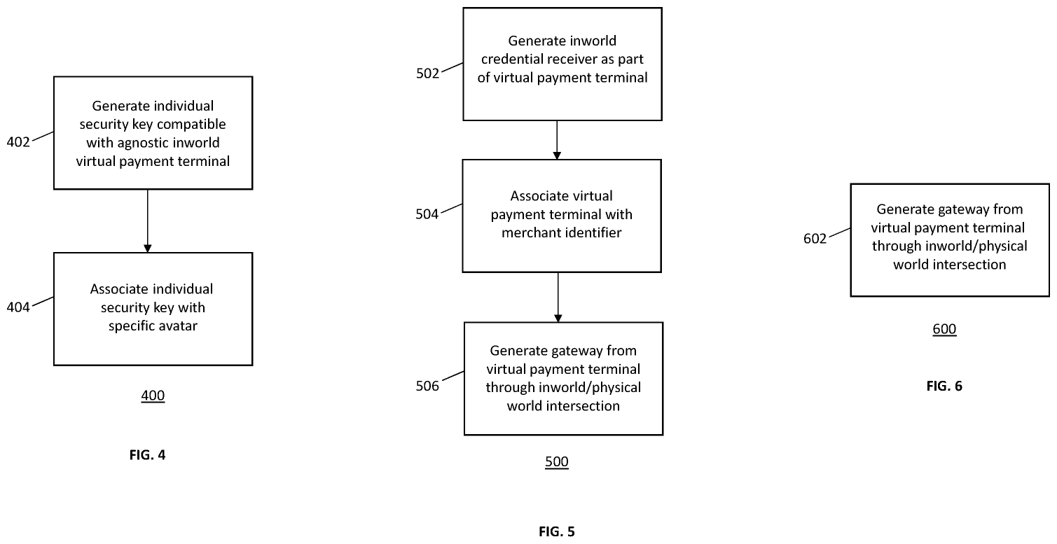

FIG. 4 is a schematic representation of a method 400 for generating an individualized avatar credential according to an embodiment of the disclosure.

The method 400 may be provided for generating the individualized avatar credential 332 for association with a specific avatar 122. The avatar credential may be used by the physical user while represented as the specific avatar 122 with a virtual terminal 334 to perform an inworld transaction. The method may include generating 402 an individual security key compatible with an agnostic inworld virtual terminal, and associating 404 the individual security key with the specific avatar. The generating 402 may include generating an encrypted security key.

In an embodiment, the generating 402 may include prompting the physical user 110 to input biometric information. For example, a physical user may be prompted to enter their voice (e.g., to words provided from a script, or to simply talk). The physical user's voice may be used to create a unique biometric token. For example, the biometric token may be a unique numeric or alphanumeric representation of the physical user's voice. The biometric input may be processed by artificial intelligence to generate the biometric token. In an embodiment, the biometric token may be the avatar credential 332.

The associating 404 may include securely storing the biometric token (i.e., the avatar credential 332) such that the biometric token, the avatar 122, and information about the physical user 110 are all associated with each other.

One or more operations of the method 400 for the generating of the individualized avatar credential may be performed by a software application (e.g., a developer plugin such as an agnostic avatar developer plugin). For example, the plugin may perform the method 400 for generating the individualized avatar credential (e.g., biometric token) for association with the specific avatar. Upon activation, the biometric token may be used with any virtual world in a metaverse so that all transactions may be tracked and assigned to specific worlds for processing and development.

FIG. 5 is a schematic representation of a method 500 for generating a virtual terminal according to an embodiment of the disclosure.

The method 500 may be provided for generating the virtual terminal 334 to be used inworld in a virtual world. The virtual terminal 334 may receive biometric input from a specific avatar to perform an inworld electronic card transaction by utilizing the biometric token. Access to use of the virtual terminal for a transaction may require verification of the biometric input against an authorized key (e.g., the biometric token). In other words, the virtual terminal may be a lock to receive the biometric input, which, with the biometric token, may form the key.

The method 500 may include generating 502 an inworld avatar biometric receiver as part of the virtual terminal, associating 504 the virtual terminal with a merchant identifier, and generating 506 a link from the virtual terminal 334 through the inworld/physical world intersection to a computing device of an authorization processor, e.g., via the intermediary processor 340. In this way transactions inworld may be in communication with an authorization processor 340 such as a typical card transaction process. In this way, inworld transactions may be tied to a physical user's physical transactions.

One or more operations of the method 500 for the generating of the virtual terminal may be performed by a software application (e.g., a developer plugin such as a virtual terminal plugin). For example, the plugin may perform the method for generating the virtual terminal. All inworld transactions of the virtual terminal may be tracked regardless of which virtual world in a metaverse the virtual terminal may be present within.

FIG. 6 is a schematic representation of a method 600 for linking a virtual terminal to be used inworld to a physical world loyalty program computing system.

The method 600 may be provided for using the virtual terminal to track loyalty card usage (or loyalty points, loyalty transactions, and the like) inworld. The method 600 may include generating a link from the virtual terminal through the inworld/physical world intersection to a computing device of a typical loyalty program, e.g., via the intermediary processor 340. The virtual terminal 334 may be provided inworld 120. The link may be similar to the link established from the virtual terminal through the inworld-physical world intersection to the computing device of the authorization processor 200. That is, the link to the computing device of the typical loyalty program may be through an intermediary processor computing device (such as intermediary processor computing device 342), or may be direct.

One or more operations of the method 600 for linking the virtual terminal to be used inworld to the physical world loyalty program computing system may be performed by a software application (e.g., developer plugin such as loyalty program developer plugin). All inworld transactions of the virtual terminal may be tracked so that all loyalty card usage, loyalty program engagement, and loyalty transactions are tracked regardless of which virtual world in the metaverse the transaction occurs within and communicated to the computing device of a typical loyalty program. In this way, inworld loyalty program engagement is tied to a physical user's physical world loyalty program.

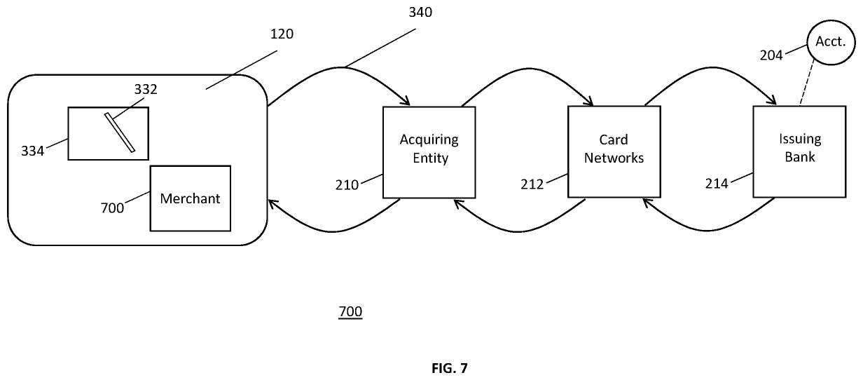

FIG. 7 is a schematic representation of a multi-factor virtual transaction according to an embodiment of the disclosure.

A physical user 110 may go inworld so as to experience and be immersed within a virtual world 120 as an avatar 122. During this immersive experience, the user 110 may desire, through user's avatar 122, to conduct a transaction, such as from an inworld merchant 700. The avatar 122 may be presented—inworld—with a virtual terminal 334 to conduct said transaction. Avatar 122 may have been created with or otherwise had associated therewith an avatar credential 332 (e.g., biometric token). The avatar credential 332 may be engaged along with biometric input provided via the virtual terminal 334 in conjunction with a transaction (e.g., an inworld purchase of a $10 USD avatar skin). The biometric input and the biometric token may be compared, e.g., by an intermediary processor 340, and if there is a successful match, the virtual terminal 334 may communicate (via the intermediary processor 340 or directly) with a computing device of the acquiring bank 210 of an authorization processor 200, such as a typical card transaction process (including outward and inward communication receiving commitment of payment on the physical user's bank/credit account by the issuing bank 214 through the card network 212).

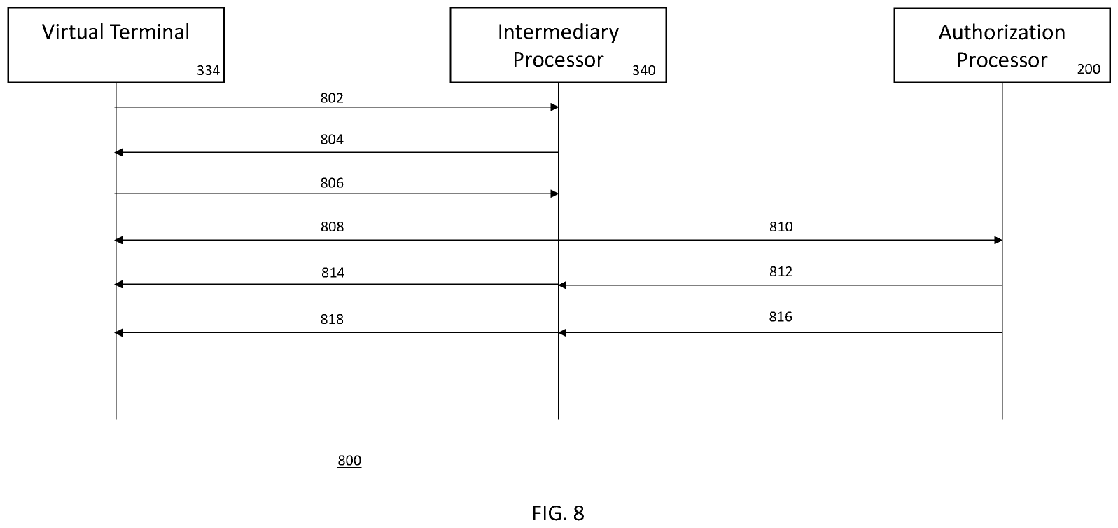

Additional detail regarding a transaction such as the transaction of FIG. 7 is now provided by referring to FIGS. 8-10, wherein an inworld gaming example is discussed. In the inworld gaming example, a physical user 110 may be immersed within an inworld game. During this immersive experience, the user 110 may desire, through the user's avatar 122, to conduct a transaction, such as purchasing a $100 USD game credit. The user 110 may interface with the virtual terminal 334 as discussed more below.

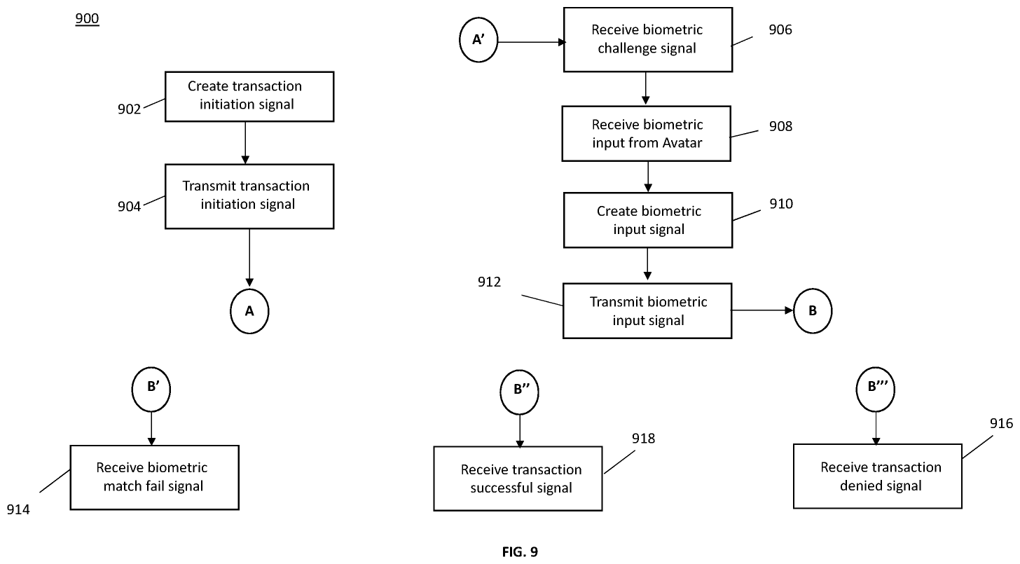

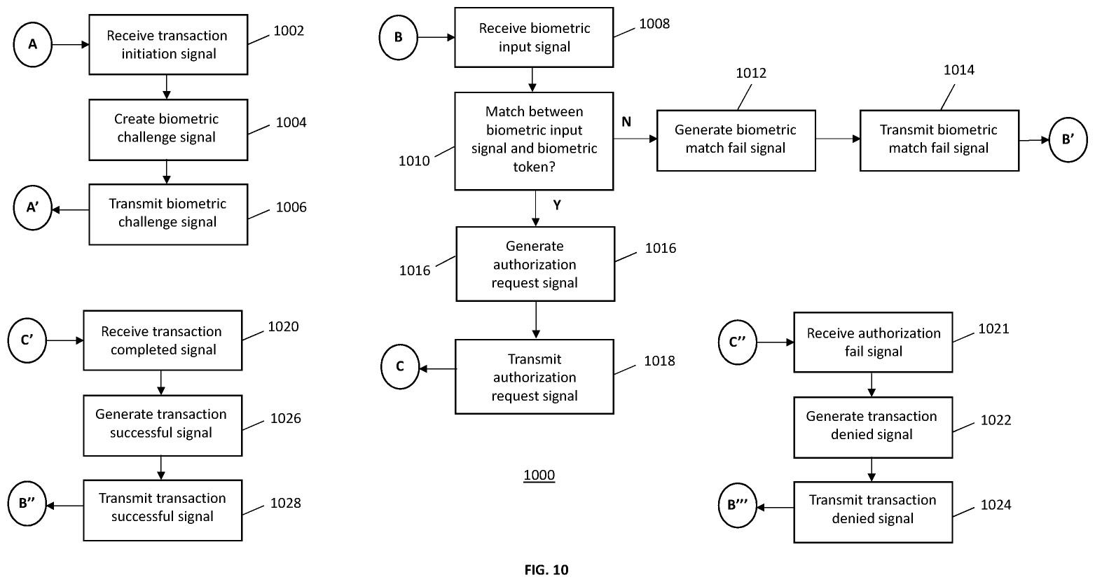

FIG. 8 is a schematic signal diagram of a multi-factor authenticated virtual transaction method 800 according to an embodiment. FIG. 9 is a schematic representation of a method 900 executing on a virtual terminal 334 according to an embodiment of the disclosure. FIG. 10 is a schematic representation of a method 1000 executing on an intermediary processor 340 according to an embodiment of the disclosure.

A transaction may be initiated by a virtual terminal 334 causing the virtual terminal 334 to create a transaction initiation signal 802 in operation 902. For example, the transaction may be initiated by an avatar 122 inworld 120. In the game virtual world example, the avatar 122 who seeks to procure the $100 USD game credit may select a procure selection inworld, e.g., using the virtual terminal 334. Upon the avatar 122 selecting the procure selection of the virtual terminal 334, creation of the transaction initiation signal may occur in the virtual terminal 334. The transaction initiation signal 802 may be transmitted from the virtual terminal 334 to the intermediary processor 340 in operation 904.

The intermediary processor 340 may receive the transaction initiation signal 802 from the virtual terminal 334 in operation 1002. The transaction initiation signal 802 may cause the intermediary processor 340 to create a biometric challenge signal 804 in operation 1004. The biometric challenge signal 804 may be transmitted from the intermediary processor 340 to the virtual terminal 334 in operation 1006.

The virtual terminal 334 may receive the biometric challenge signal 804 from the intermediary processor 340 in operation 906. The biometric challenge signal 804 may cause the virtual terminal 334 to receive a biometric input from the avatar 122 in operation 908. The biometric input may be an appropriate biometric of the physical user 110 that is using the avatar 122. For example, in the game virtual world example, the virtual terminal 334 may require the avatar 122 to speak (e.g., into their game microphone) so as to record the voice of the avatar 122 (e.g., the voice of the physical user 110) as the biometric input.

The receipt of the biometric input may cause the virtual terminal 334 to create a biometric input signal 806 in operation 910. For example, the biometric input signal may be a digital file representing the biometric input. In the game virtual world example, the biometric input (e.g., the voice of the physical user as prompted for, received, and stored as a digital file) may be embodied as the biometric input signal 806. The biometric input signal 806 may be transmitted from the virtual terminal 334 to the intermediary processor 340 in operation 912.

The intermediary processor 340 may receive the biometric input signal 806 from the virtual terminal 334 in operation 1008. The biometric input signal 806 may cause the intermediary processor 340 to compare the received biometric input with a biometric token to determine whether a match occurs in operation 1010.

If a match does not occur (NO result from operation 1010), the intermediary processor 340 may generate a biometric match fail signal 808 in operation 1012. The biometric match fail signal 808 may be transmitted from the intermediary processor 340 to the virtual terminal 334 in operation 1014 and the method 1000 may terminate. The virtual terminal 334 may receive the biometric match fail signal 808 in operation 914 and the method 900 may terminate. In the game virtual world example, the physical user's avatar 122 may fail to receive the desired game credit.

If a match does occur (YES result from operation 1010), the intermediary processor 340 may generate an authorization request signal 810 in operation 1016. The authorization request signal 810 may be transmitted from the intermediary processor 340 to an authorization processor 200 in operation 1018. The authorization request signal 810 may include or cause transmission of a payment token. For example, in the game virtual world example, if the user's voice matches the biometric token, the intermediary processor 340 may generate/send communications to the physical user's typical card transaction process so as to receive commitment of payment on the physical user's bank/credit account by an issuing bank through a card network. In an embodiment, the user's payment token may be used in this process.

The intermediary processor 340 may receive a transaction completed signal 812 in operation 1020 or an authorization fail signal 816 in operation 1021 from the authorization processor 200.

If the authorization fail/denied signal 816 is received (operation 1021), the intermediary processor 340 may generate a transaction denied signal 818 in operation 1022. The transaction denied signal 818 may be transmitted from the intermediary processor 340 to the virtual terminal 334 in operation 1024 and the method 1000 may terminate. The virtual terminal 334 may receive the transaction denied signal 818 in operation 916 and the method 900 may terminate. In the game virtual world example, the physical user's avatar 122 may fail to receive the desired game credit.

If the transaction completed signal 812 is received (operation 1020), the intermediary processor 340 may generate a transaction successful signal 814 in operation 1026. The transaction successful signal 814 may be transmitted from the intermediary processor 340 to the virtual terminal 334 in operation 1028 and the method 1000 may terminate. The virtual terminal 334 may receive the transaction successful signal in operation 918 and the method 900 may terminate. In the game virtual world example, the physical user's account may be debited/credited, and the avatar 122 may receive the $100 USD game credit.

While the above example embodiments have been described with respect to funds/credit availability verification, many different embodiments are contemplated and are within the scope of the present disclosure. For example, biometric authorization may be implemented in conjunction with telehealth and related records, online gaming, gambling terminals, online gambling, brick and mortar payment systems, virtual to real world payment systems (similar to those discussed herein), document certification, digital fraud prevention, payments, cyber security, tokenization of digital assets, voter verification, and the like.

A computing device (such as the intermediary processor computing device 342) may include one or more processors, memory, interfaces (human and/or communication), and software (such as operating system software). It should be understood that computing devices (such as the intermediary processor computing device 342) may be hosted on a cloud computing services platform including multiple computing devices operating as an entity.

As noted above, artificial intelligence may be applied to certain processes of the present embodiments. For example, while the above discussion describes applying artificial intelligence to an input biometric to generate a biometric token, artificial intelligence may similarly be applied in the verification of the biometric token as well as in logging operations that log each individual transaction. Non-limiting example artificial intelligence platforms include OPENAI and MICROSOFT AI. Additionally, blockchain technologies may be applied to certain operations of the present embodiments, including the logging operations.

According to embodiments of the present disclosure, multi-factor authenticated virtual transactions (e.g., payment and refunds) may be conducted using a physical world authorization processor (e.g., a physical world electronic card transaction system) after confirming a biometric input using a biometric token. These transactions may be conducted inworld, without the need to leave a particular virtual world, such as for a separate payment area. Similarly, inworld loyalty program engagement may be tied to physical world loyalty programs. Providing such seamless access while engaged inworld simplifies inworld purchases and transactions, and opens new markets (i.e., virtual worlds). By providing developer plugins for avatar creation, virtual terminal development and deployment, and loyalty program linking, the process of adopting and deploying the current systems and methods is simplified. It should be appreciated that the nature of the present embodiments provides additional benefits beyond the few mentioned here. Such benefits will be apparent to one of ordinary skill in the art.

A few example embodiments have been disclosed herein and are not for purposes of limitation. It is apparent to one of ordinary skill in the art that elements of the embodiments may be combined. It is apparent to one of ordinary skill in the art that various changes in form and details of the embodiments may be made without departing from the spirit and scope of the disclosure.

What is claimed is:

1. A multi-factor authenticated virtual transaction method of an intermediary processor, comprising:
receiving, into the intermediary processor, a transaction initiation signal;
generating a biometric challenge signal in response to the receiving of the transaction initiation signal;
transmitting, towards a virtual terminal, the biometric challenge signal;
receiving, from the virtual terminal, a biometric input signal including biometric input;
comparing the received biometric input and a biometric token to determine whether a match occurs;
when the match does not occur:
transmitting a biometric match fail signal to the virtual terminal;
when the match does occur:
generating an authorization request signal;
transmitting the authorization request signal towards an authorization processor; and
receiving a response to the authorization request signal.

2. The multi-factor authenticated virtual transaction method of claim 1, wherein the biometric input is a voice input.

3. The multi-factor authenticated virtual transaction method of claim 1, wherein the biometric token comprises a unique alphanumeric or numeric representation created based on the biometric input.

4. The multi-factor authenticated virtual transaction method of claim 1, wherein at least one of the generating of the authorization request signal and the transmitting of the authorization request signal include providing data for use with a payment token.

5. The multi-factor authenticated virtual transaction method of claim 1, wherein the response to the authorization request signal comprises an authorization denied signal or a transaction completed signal.

6. The multi-factor authenticated virtual transaction method of claim 5, wherein
the response to the authorization request signal comprises the authorization denied signal, and
the multi-factor authenticated virtual transaction method further comprises:
generating a transaction denied signal; and
transmitting the transaction denied signal toward the virtual terminal.

7. The multi-factor authenticated virtual transaction method of claim 5, wherein:
the response to the authorization request signal comprises the transaction completed signal, and
the multi-factor authenticated virtual transaction method further comprises:
generating a transaction successful signal; and
transmitting the transaction successful signal toward the virtual terminal.

8. A multi-factor authenticated virtual transaction method of a virtual terminal, comprising:
generating a transaction initiation signal;
transmitting, towards an intermediary processor, the transaction initiation signal;
receiving, from the intermediary processor, a biometric challenge signal;
receiving a biometric input;
generating a biometric input signal including the biometric input; and
transmitting the biometric input signal toward the intermediary processor.

9. The multi-factor authenticated virtual transaction method of claim 8, wherein the biometric input is a voice input.

10. The multi-factor authenticated virtual transaction method of claim 8, further comprising:
receiving a biometric match fail signal.

11. The multi-factor authenticated virtual transaction method of claim 8, further comprising:
receiving a transaction denied signal.

12. The multi-factor authenticated virtual transaction method of claim 8, further comprising:
receiving a transaction successful signal; and
performing completion operations for the multi-factor authenticated virtual transaction.
